(19) United States
(12) Patent Application Publication
(10) Pub. No.: US 2025/0278085 A1
(43) Pub. Date: Sep. 4, 2025

(54) ENHANCED EMITTERS, SENSORS AND INDICATORS FOR REMOTE-CONTROLLED DRONES

(71) Applicant: Creative Drones, Inc., Lewes, DE (US)

(72) Inventors: Alan R. Stein, Petaluma, CA (US); Joaquin Aguerrebere Gutierrez, Playa del Carmen (MX)

(21) Appl. No.: 19/065,164

(22) Filed: Feb. 27, 2025

Related U.S. Application Data
(60) Provisional application No. 63/559,430, filed on Feb. 29, 2024.

(51) Int. Cl. G05D 1/226; G05D 109/20; G05D 111/30

(52) U.S. Cl. CPC G05D 1/226; G05D 2109/20; G05D 2111/32

(57) ABSTRACT

A system including an emitter drone including one or more emitters that are configured to emit signals and a receiver drone including one or more receivers that are configured to detect an emitted signal from the emitter drone. The system further includes a controller that is configured to provide a detection signal when the one or more receivers detect the emitted signal from the emitter drone and an indicator that provides an indication based on receiving the detection signal from the controller of the receiver drone.

### CROSS-REFERENCE TO RELATED APPLICATIONS

This application claims the benefit of U.S. Provisional Application No. 63/559,430, filed on Feb. 29, 2024, which is incorporated herein by reference.

### FIELD

This specification describes enhanced emitters, receivers and indicators that are used with remote-controlled drones.

### BACKGROUND

A remote-controlled drone is a type of small-scale unmanned aerial vehicle (UAV). A remote-controlled drone can be operated by individuals, and can fly in a three-dimensional space within range of a hand-held, user-operated controller.

### SUMMARY

This specification describes enhanced emitters, receivers and indicators for remote-controlled drones. The enhanced emitters, receivers and indicators are configured to allow a drone (an “emitter drone”) to emit signals, e.g., electromagnetic energy, toward another drone (a “receiver drone”), to allow a receiver drone to receive signals that are emitted by emitter drones. In some examples, the emitters can be operated by a user or operated by a remote device (e.g., automatically operated). The enhanced emitters, receivers and indicators allow a received drone to generate, act upon, or provide local or remote indications, e.g., control commands, or visual, audio, or haptic indications, in response to the receiver drone receiving a signal from an emitter drone.

By emitting signals toward the receiver drone, the emitter drone may aid the receiver drone in performing a task, may aid either drone in remaining in formation or avoiding collision, or may signal the emitter drone's position to the receiver drone for any other desired purpose. In receiving select signals from the emitter drone, a receiver drone may determine that the emitter drone is in a particular position with respect to the receiver drone, may aid the receiver drone in remaining in formation or avoiding collision, or may use the received signals for any other desired purpose. In indicating that the receiver drone has received the signals emitted by the emitter drone, an indicator may signal to a human, e.g., human operators or spectators, or to computers, or to satellites or aircraft that are monitoring the drones, or to either the emitter drone or the receiver drone, that the signals have been transmitted by one drone or received by the other drone. The enhanced emitters, receivers and indicators may allow individual drones or formations of drones to perform maneuvers that are typically difficult to perform without an expert-trained operator, or allow individual drones or formations of drones to operate autonomously, e.g., at least partially autonomous, or with fewer human operators or control inputs.

By adjusting or configuring a receiver associated with a receiver drone, e.g., by adjusting an aperture, filter, antenna or opening to face a certain direction, the receiver drone may limit detections of signals emitted by the emitting device to only detect signals that are emitted when the emitter drone is in a particular position or orientation with respect to the receiver drone, e.g., only when the emitter drone is directly behind the receiver drone.

The subject matter described in this specification can be implemented in particular embodiments so as to realize one or more of the following advantages. By illuminating the receiver drone with the signals, the emitter drone can make both drones more visible when performing a drone formation, can reduce the chances of a collision, and/or can aid the navigation of both drones. The enhanced emitters, receivers, and indicators can provide drones and human operators with additional situational awareness, allowing drones to perform more complicated tasks or maneuvers and to increase opportunities for autonomous operation. Because the drones can move at very high speed with relation to each other, the enhanced emitters, receivers and indicators allow for the generation of alerts to the drones, humans or downstream processing pipelines regarding the positioning of one drone in relation to another, in real-time or near real-time, in a manner that is objective, and that is not capable of being performed with the human eye. The signals can be used to determine a number of times an emitter drone has illuminated the receiver drone with one or more signals, e.g., has “tagged” the receiver drone, and/or the duration of time that the emitter drone has tagged the receiver drone, or both.

In one general implementation, the receiver drone can receive a signal that is emitted from an emitter drone when the emitter drone is emitting signals and is in a particular position or orientation with respect to the receiver drone. The receiver drone can generate a detection signal, and the receiver drone can provide the detection signal for output.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A illustrates the enhanced transmitters, receivers, and indicators according to one example implementation.

FIG. 1B illustrates an example system including an emitter device of an emitter drone and a target device of a receiver drone.

FIG. 2 illustrates a schematic diagram of an example system.

FIG. 3 is a perspective view of an example housing for an emitter device of an emitter drone.

FIG. 4 is a rear perspective view of an example housing for an emitter device of an emitter drone.

FIG. 5 is a side view of the example housing for an emitter device of an emitter drone.

FIG. 6 is a perspective view of an example housing for a target device of a receiver drone.

FIG. 7 is a cross-sectional view through a center plane of an example housing for a target device of a receiver drone.

FIG. 8 is a cross-sectional view through plane A-A shown in FIG. 7.

FIG. 9 is a perspective view of a 14-segment display.

FIG. 10 illustrates an example of an enhanced indicator.

FIG. 11 illustrates another example an enhanced indicator.

In the drawings, like reference numerals refer to like elements throughout.

### DETAILED DESCRIPTION

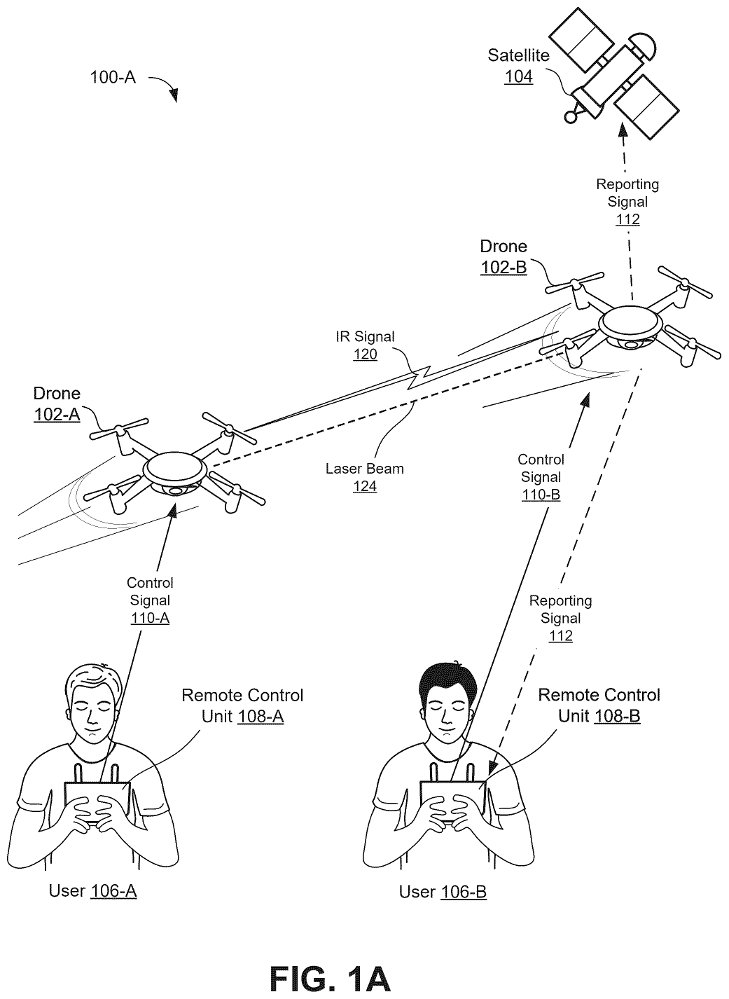

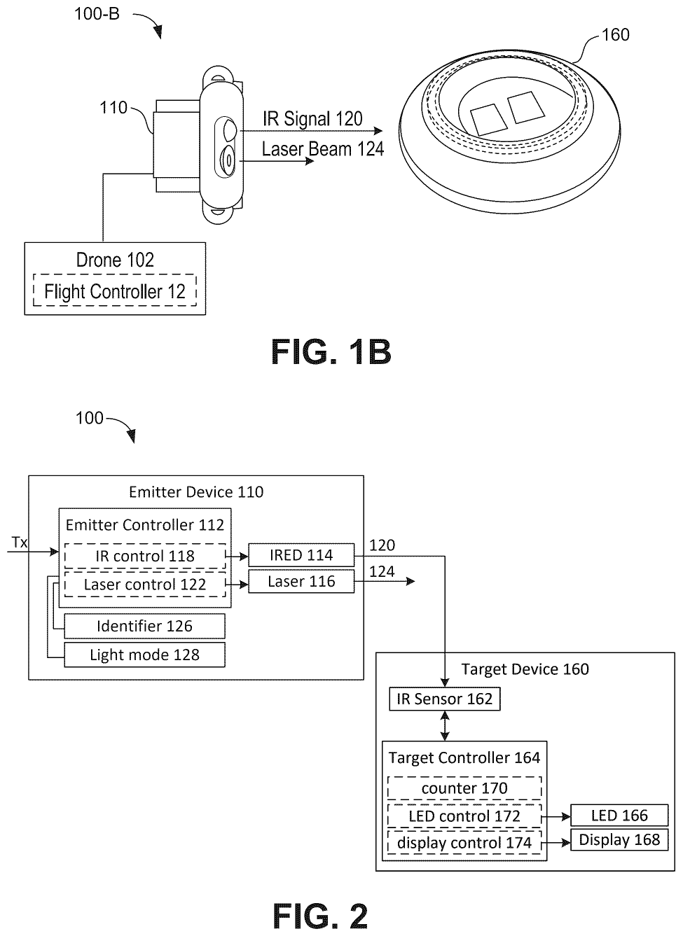

FIG. 1A illustrates the enhanced transmitters, receivers, and indicators according to one example implementation. A system 100 may include a first device (e.g., an emitter device) and a second device (e.g., a receiver device). For example, as shown in FIG. 1A, an emitter device can be coupled to a first drone 102-A, e.g., an emitter drone 102-A controlled by a first user 106-A using the remote control unit 108-A and a receiver device can be coupled to a second drone 102-B, e.g., the receiver drone 102-B controlled by a second user 106-B using the remote control unit 108-B. The remote control units 108 are configured to emit and receive signals from the drones 102. In some examples, the system 100-A may further include an airborne or spaceborne platform, e.g. satellite 104, that is configured to receive signals from one or more of the drones 102. In some other examples, the emitter device, the receiver device, or both can be standalone devices that are controlled by a user 106, by a remote device, or both. That is, the emitter device and the receiver device can be a drone 102, an unmanned aerial vehicle (UAV), a wearable device, a stationary device, e.g., an obstacle associated with a drone racing course, or any other appropriate device.

Each drone 102 is configured to emit signals having one or more particular wavelengths in the direction of the other drone 102 using an emitter device coupled to the emitter drone 102-A. For example, the emitter drone 102-A can emit signals, e.g., electromagnetic energy having one or more particular wavelengths, such as mmwave, LiDAR, visible light, ultrasonic, etc. That is, the emitter drone 102-A can illuminate a receiver drone 102-B with a signal using an emitter device coupled to the emitter drone 102-A, and the receiver drone 102-B can receive the signal at a target device coupled to the drone 102-B. In some instances, the received drone 102-B receives signals from the emitter drone 102-A only when the emitter drone 102-A is positioned or oriented in a particular orientation or position with respect to the receiver drone 102-B when the signal is generated, e.g., behind, aside, or diving towards the receiver drone 102-B.

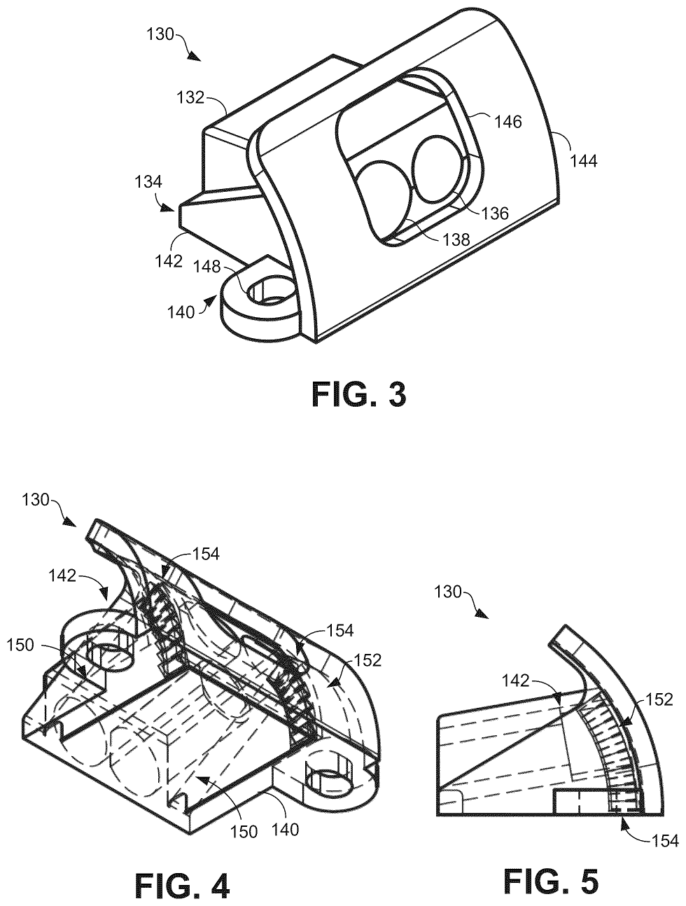

In some implementations, the first user 106-A can “tag” a target device of the receiver drone 102-B with a signal emitted from an emitter device that is coupled to and interfaced with the emitter drone 102-A. The term “tag” as used herein refers to the reception of one or more signals generated by a first device (i.e. emitter device) and detected by a sensor in a second device (i.e. target device). The target device may be configured to detect the signal received by a sensor and provide an indication that the target device has been tagged. For example, the target device may generate a visual indication that the device has been tagged. In various examples, the target device may count the number of times the signal, or type of electromagnetic wave, has been received and optionally display the count and/or score, as described in further detail below with reference to FIGS. 3-11.

The enhanced emitters, receivers and indicators may include an emitter device that is configured to interface with a drone 102. The enhanced emitter may be integral to the frame of a drone 102, or may be removably attached to the frame of the drone 102. The emitter device may include an emitter controller, and one or more emitters that emit signals, such as acoustic or electromagnetic waves, e.g., an infrared emitter, a laser emitter, an ultrasonic emitter, a visual light emitter, an ultraviolet emitter, and/or other emitter that has an eye-safe power level. For example, the electromagnetic waves may have a wavelength that is longer than 1.4 micrometers.

In some examples, the emitter device can be operably connected to the emitter controller to emit signals in their respective wavelengths, e.g., an infrared signal and a laser beam having an eye-safe power-level aligned in substantially the same direction. In this case, the target device can include an infrared sensor and a target controller. In some examples, the target device is configured to provide at least a visual indication in response to receiving the infrared signal emitted from the emitter device. In some other examples, the target device is configured to transmit a signal to a computing unit of the drone 102, and the drone 102 can display the visual indication in response to receiving the infrared signal emitted from the emitter device.

For example, the emitter device can be configured to emit an infrared signal with a predefined protocol selected to correspond to a specific emitter device. In this case, individual emitter devices coupled to individual emitter drones 102-A of multiple drones 102 may each be configured to emit a unique infrared signal with a user selected predefined protocol to distinguish the individual drone 102 from the other drones 102 when the signal is received by the target device of the receiver drone 102-B to illuminate a particular other drone 102. For example, the target device may provide a first visual indicator for an infrared signal with a first predefined protocol received and a second visual indicator for an infrared signal with a second predefined protocol received. The visual indicator can include lights (e.g., illumination), sounds, and/or data stored onto a remote location, and the visual indicator can be located in one or more locations (e.g., the target device, the emitter device, and/or a remote location, such as a user device associated with the users 106.

For example, he visual indicator may include illumination of the target device, wherein the illumination may have a different color or flashing pattern based on the predefined protocol received. In general, the receiver drone 102-B can receive a signal, e.g., an IR signal 120 that is emitted from the emitter drone 102-A when the emitter drone 102-A is emitting signals, e.g., the IR signal 120 and the laser beam signal 124 and when the emitter drone 102-A is in a particular position or orientation (e.g., proper alignment) with respect to the receiver drone 102-B. The emitted signal can encode data associated with the emitter drone 102-A or the receiver drone 102-B. That is, the signal can be received by the receiver drone 102-B only when the emitter drone 102-A is directly behind the receiver drone 102-B and/or diving toward the receiver drone 102-B. For example, the emitter device of the emitter drone 102-A can have a particular scope of the signal (e.g., size, shape, and/or intensity of the signal through space), and the target device of the receiver drone 102-B can have a particular target area (e.g., a particular sensitivity), such that the emitter device must be in alignment with the target device for the target device to receive the signal. In some examples, the scope of the signal and/or the target area can be adjusted in size and/or shape (e.g., by physical obstructions, such as a hood).

The receiver drone 102-B can then generate a detection signal, e.g., the reporting signal 112, and the receiver drone 102-B can provide the detection signal for output, e.g., to the remote control unit 108-B, the satellite 104, or both. For example, the controller is configured to provide the output when the one or more receivers detect the signal from the emitter drone for more than a threshold amount of time. In another example, the controller is configured to provide the output when the one or more receivers detect the signal from the emitter drone more than a threshold number of times.

In the example of FIG. 1A, each user can control a particular drone to perform one or more actions in an environment. For example, the users 106 can control the drones 102 to follow one another, e.g., to chase one another, such that one drone 102 can tag another drone 102. That is, one or more emitters, e.g., emitter devices of the emitter drone 102-A can emit a signal to one or more receivers, e.g., target devices of the receiver drone 102-B to tag the receiver drone 102-B. The one or more receivers of the receiver drone 102-B can detect the signal only when the emitter drone is in a particular position or orientation with respect to the receiver drone 102-B. In some examples, the receiver drone 102-B can have a filter that prevents the one or more receivers from detecting the emitted signal from one or more directions. That is, the emitter drone 102-A must in this example emit the signal from a particular direction for the receiver to detect that the receiver drone 102-B has been tagged. In this case, the filter of the receiver drone 102-B can be an aperture, e.g., an opening that the emitted signal must enter through for the receiver drone 102-B to be tagged.

In particular, the user 106-A can control the emitter drone 102-A using the remote control unit 108-A, and the user 106-B can control the receiver drone 102-B using the remote control unit 108-B. That is, each respective remote control unit 108 can transmit one or more control signals 110 to the respective drone, where each control signal 110 indicates for the drone to perform a particular movement, to transmit a signal for illuminating another drone 102, or both.

In particular, the user 106-A can transmit a control signal 110-A to the emitter drone 102-A via the remote control unit 108-A. For example, the control signal 110-A can indicate for the emitter drone 102-A to emit one or more particular wavelengths, e.g., an infrared (IR) signal 120 and a laser beam signal 124 using the emitter device to a receiver, e.g., a target device of a receiver drone 102-B. In this case, the signals 120 and 124 can illuminate the receiver drone 102-B. In some examples, based on a target device of the receiver drone 102-B receiving the signals 120 and 124, the receiver drone 102-B can transmit a reporting signal 112 to the remote control unit 108-B. The reporting signal 112 can indicate that the receiver drone 102-B has been tagged. That is, the reporting signal 112 can indicate that the one or more receivers detected the signal from the emitter drone 102-A for more than a threshold amount of time. In another example, the reporting signal 112 can indicate that the one or more receivers detect the signal from the emitter drone 102-A more than a threshold number of times. In some examples, the reporting signal 112 can indicate a location of the drone 102-B.

In some examples, the receiver drone 102-B can perform a simulated hit flight maneuver in response to the receiver of the receiver drone 102-B detecting the signal. That is, the receiver drone 102-B can perform a particular movement based on being tagged by the emitter drone 102-A.

In some examples, the receiver drone 102-B can transmit the reporting signal 112 to a satellite 104 configured to receive one or more signals from the drones 102. In this case, the satellite 104 can report the reporting signal 112 to a remote system, e.g., a remote computing system. For example, the remote system can receive a signal indicating a location of the particular drone 102, and the remote system can generate a formation or a navigation route based on the signal.

Thus, by illuminating the receiver drone 102-B, the emitter drone 102-A can make both drones 102 more visible, such that the drones can more efficiently align with each other and/or other drones 102 in a drone formation, which allows the drones 102 to perform more complicated tasks or maneuvers and to increase opportunities for autonomous operation. In another example, illuminating the receiver drone 102-B can reduce the chances of a collision. That is, the particular drone 102 can be more visible in a formation or more visible in general to allow the drone 102 transmitting the one or more signals to navigate more easily and more efficiently without colliding with each other.

Additionally, because the drones can move at very high speed with relation to each other, the enhanced emitters, receivers and indicators allow for the generation of alerts to the drones 102, users, or downstream processing pipelines regarding the positioning of one drone 102 in relation to another, in real-time or near real-time, in a manner that is objective, and that is not capable of being performed with the human eye. That is, by transmitting a reporting signal 112 to a remote control unit 108 and/or a satellite 114, the system allows for a user of the system to identify a location of a drone 102, which can increase efficiency in drone formation and/or drone navigation. Lastly, the transmitted signals can be used to determine a number of times an emitter drone 102-A has illuminated the receiver drone 102-B with the one or more signals, e.g., has “tagged” the receiver drone 102-B, and/or the duration of time that the emitter drone 102-B has tagged the receiver drone, or both.

As shown in FIG. 1B, the system 100 may include an emitter device 110 of an emitter drone 102-A and a target device 160 of a receiver drone 102-B. The emitter device 110 is suitable to interface with the receiver drone 102-B to receive a trigger signal, as well as physically couple to at least one surface of the drone 102. The drone 102 may be a user provided drone with a flight controller 12 programmable by the user. For example, the drone 102 may be a multi-rotor hobby drone built for racing or freestyle use with a flight controller firmware programmable with an open source software. The emitter device 110 may draw power from a battery on the emitter drone 102-A or be powered by a separate battery. The system 100 may include one or more emitter devices 110 suitable to couple to corresponding one or more user provided drones 102. The system 100 may also include one or more target devices 160 configured to detect a signal emitted by one or more emitter devices 110.

As shown in FIG. 2, the emitter device 110 can include an emitter controller 112, an infrared emitter 114, and a laser emitter 116. The emitter device 110 may be configured to receive a wavelength signal from the user provided drone 102, e.g., the emitter drone 102-A. For example, the emitter device 110 may be wired to the flight controller 12 of the emitter drone 102-A, to receive a control signal 110, e.g., transmit signal (Tx) in response to a command from a remote control unit 108 (also referred to as a handset or remote control unit herein) corresponding to the user's drone 102. The emitter controller 112 is separate from the flight controller 12, only receiving the transmit signal as programmed by the user 106.

In some examples, the emitter controller 112 can include an infrared (IR) controller 118 configured to control an infrared light or infrared signal 120 generated by the infrared emitter 114 and a laser controller 122 configured to control laser light or laser beam 124 generated by the laser emitter 116. The infrared emitter 114 and the laser emitter 116 are operably connected to the emitter controller 110 to simultaneously emit an infrared signal 120 and a laser beam 124 in response to a trigger signal (Tx) received from a flight controller 12 of the drone 10. The emitter controller 110 can further include a user selectable identifier 126 to emit an infrared signal 120 with a predefined protocol corresponding to the selectable identifier 126.

For example, the user may select an ID corresponding to infrared signal with a predefined protocol to identify the emitter drone 102-A that emitted the infrared signal 120. The emitter controller 110 may also include a selectable light mode 128 to adjust an intensity of the infrared light emitted. For example, the user may select a day or night mode for the infrared emitter 114. The infrared emitter 114 and the laser emitter 116 are configured to operate at an eye-safe power level or intensity. For example, the laser emitter 116 may emit light at human-visible wavelength (i.e. about 380 nm to about 750 nm).

As noted above, the emitter device 110 is configured to simultaneously emit one or more signals from one or more emitters. For example, the emitter device 110 can emit an infrared signal 120 and/or a laser beam 124 from the infrared emitter 114 and the laser emitter 116, respectively. The infrared emitter 114 may be an infrared light emitting diode (LED) and the laser emitter 116 may be a laser LED. The infrared emitter 114 and the laser emitter 116 are configured to operate at an eye-safe power level. The infrared emitter 114 and the laser emitter 116 are aligned such that the infrared signal 120 and the laser beam 124 are directed in substantially the same targeting direction. While both infrared and visible light are generated by the emitter device 110, the laser beam 124 is intended as a visual guide for the user to distinguish where the infrared signal 120 is being directed. As will be discussed in further detail, the target device 160 is configured to detect and receive the infrared signal 120 that is generated by the emitter device 110.

Shown in FIGS. 1 and 3, the infrared emitter 114 and the laser emitter 116 are contained within a housing 130 suitable to align said emitters 114, 116 and direct the infrared signal 120 and the laser beam 124 in substantially the same targeting direction. The housing 130 comprises a casing 132 and a frame 134 that is suitable to hold the casing 132. The casing 132 is suitable to contain and align the infrared and laser emitters 114, 116 such that emission direction of the infrared and laser emitters 114, 116 are aligned. The casing 132 may include first and second seats 136, 138 configured to hold said emitters 114, 116 in alignment. The frame 134 may include a base 140, a pair of arms 142 extending from the base 140, and a shield 144 coupled to the base 140 and the pair of arms 142. The housing 130 is adapted to be secured to a surface of the drone 10. The shield 144 may include a shield aperture 146 suitable to allow the transmission of the infrared signal 120 and the laser beam 124 through the shield aperture 146. The base 140 may include coupling means to secure the emitter device 110 to the drone. As shown in the illustrative example, the base 140 may include apertures 148 in the base to receive fasteners, such as bolts, to secure the emitter device; however, other means of securing the emitter device 110 to the drone may be relied on. When the user provided drone 102 includes a drone camera for a first person view (FPV) of the aerial space, the emitter device 110 may be mounted on the emitter drone 102-A such that the center of view of the drone camera is aligned with the laser beam 124.

As shown in FIGS. 4-5, each arm 142 of the pair of arms 142 may include an interior surface 150 with an arcuate portion 152 having a plurality of teeth 154 spaced at an interval. The pair of arms 142 are positioned such that the respective arcuate portion 152 of each arm 142 with plurality of teeth 154 face each other. The casing 132 is pivotably coupled to the base 140 of the frame 134 and has a pair of protrusions 156 (not shown) suitable to selectively engage with the plurality of teeth 154 to select an angle of emission direction. For example, the user can select a preferred position on the emitter drone 102-A to install the emitter device 110 and also adjust the angle with respect to the surface of the drone. The user may choose to select the angle of emission direction so that the emission is not obstructed by another structure on the drone or for other advantageous reasons.

As illustratively shown in FIG. 2, a target device 160 may include an infrared sensor 162, a target controller 164, a plurality of signaling LEDs 166, and a display 168. The target controller 164 is operatively connected to the infrared sensor 162 and is configured to detect and receive an infrared signal 120 that is generated by the emitter device 110. While both infrared and visible light are generated by the emitter device 110, the target device 160 is configured for detecting the infrared signal 120 and the directionally aligned laser beam 124, intended as a visual guide, is not detected. The target device 160 may be configured to provide at least a visual indication in response to detecting infrared signals 120 received by the infrared sensor 162. The target controller 164 may also include a counter 170, an LED control 172, and a display control 174. The counter 170 may be configured to incrementally track a number of one or more types of infrared signals 120 received by the infrared sensor 162. Advantageously, emitting the visible light can increase user safety by warning users of the emission of the infrared light, such that users can be warned to avert their gaze and avoid possible damage to their eyes.

The target device 160 may be configured to illuminate one or more LEDs 166 in response to detecting an infrared signal 120 by the infrared sensor 162. The target controller 164 may be configured to illuminate the plurality of signaling LEDs 166 in a predetermined color, or set of colors, based on the type of the infrared signal received. The target controller 164 may be configured to illuminate individual ones of the plurality of signaling LEDs 166 in a predetermined sequence based on the type of infrared signal received. The target device 160 may further include a display 168 operably connected to the target controller 164. The display 168 may be configured to display the number tracked of the one or more types of infrared signals received. In various examples, the display 168 of the target device 160 may be a 14-segment display 190. Although the 14-segment display 190 is shown as an illustrative example, other types of displays suitable to display a count or score can be relied on for the target device 160.

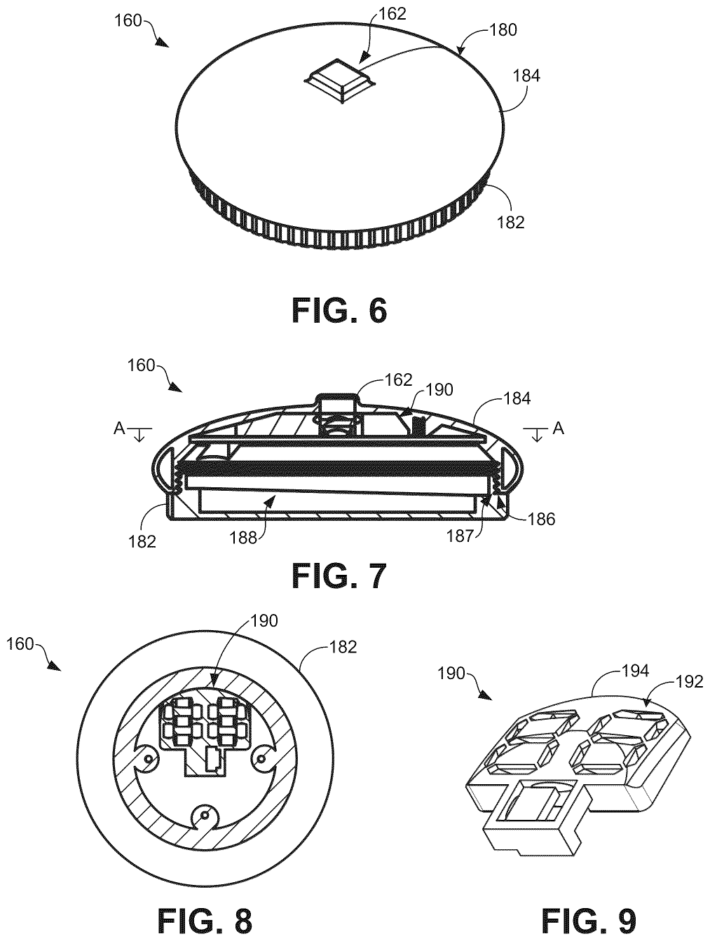

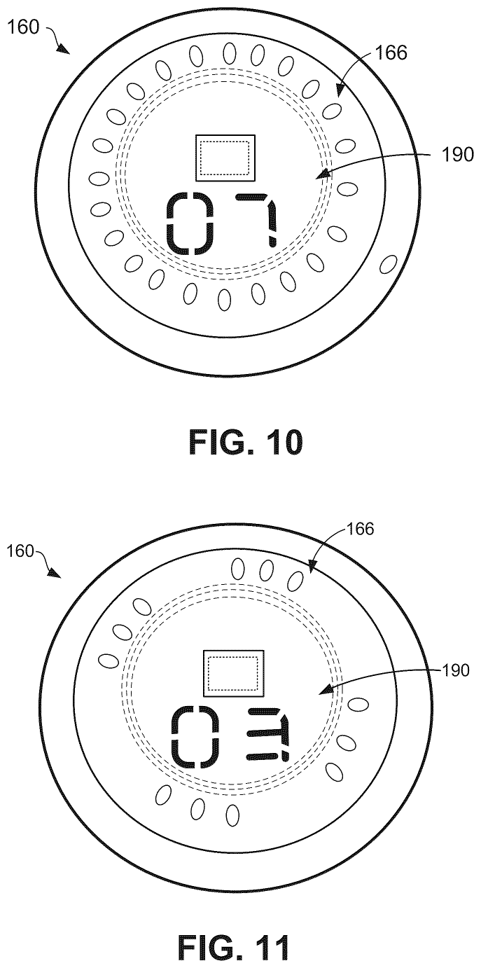

As shown in FIG. 6-8, the target device 160 may also include a target enclosure 180 configured to contain at least the infrared sensor 162 and the target controller 164. In the illustrative embodiment, the target enclosure 180 may include a base 182 and a cover 184. The infrared sensor 162 may be coupled to the cover 184 to receive an infrared signal therethrough. The plurality of signaling LEDs 166 may be arranged within a target enclosure 180 and operatively connected to the target controller 164. For example, the plurality of signaling LEDs 166 may be between 18-36 LEDs arranged to encircle a central area under the cover 184. Similarly, the display may be arranged within the target enclosure 180. The cover 184 may be made from translucent material such that the light emitted from the LEDs 166 or display 168 may be viewed through the cover (FIGS. 10-11).

In various examples, the cover 184 may include a threaded portion 186 about an interior surface of the cover 184 such that the base 182 may be coupled to the cover 184 by engaging a threaded portion 187 of the base 182 with the threaded portion 186 of the cover 184. In the illustrative example, an interior portion of the base 182 may include an incline or ramp 188 configured as a switch, such that when the cover 184 is fully screwed into the base 182, a connector to a battery that powers the device 180 is engaged, turning on the device. Similarly, when the cover 184 is partially unscrewed from the base 182, a connector to a battery that powers the device 180 is disengaged and in an off position. The target device 160 may be powered by an internal battery. For example, the target device 160 may include a replaceable or rechargeable battery. Although the illustrative embodiment shows an example of the base 182 and cover 184 having physical features to switch the device on and off, other switches or devices may be relied on for activating the target device 160.

As shown in an illustrative example in FIGS. 8-9, the 14-segment display 190 may be used to display a score related to a number of one or more types of infrared signals 120 received by the infrared sensor 162 and incrementally tracked by the counter 170. Although other types of displays may be relied upon, the 14-segment display 190 includes 14 LEDs 192 arranged and encased in a mask 194 and coupled to the target controller 164. The 14 LEDs 192 are arranged in a pattern that resembles the number 88, which is further defined by the mask 194 to improve readability. For example, if all 14 LEDs 192 are illuminated, the number 88 would be visible. The display control 174 is configured to illuminate individual LEDs of the 14 LEDs 192 to emulate the numbers 0-99 and some letters of the English alphabet. For example, the count or score indicating the number of infrared signals 120 received may be displayed using the 14-segment display 190. In some examples, the 14-segment display 190 is controlled by the display control 174 and operates separately from the plurality of signaling LEDs 166 controlled by the LED control 172. In various examples, the LEDs of the 14-segment display 190 are controlled along with the plurality of signaling LEDs 166 controlled by the LED control 172. For example, the LEDs of 14-segment display may be on the same circuit as the plurality of signaling LEDs 166 and are controlled by the same signal, which has the benefit of minimizing the number of controller output pins needed. In an example, the 14-segment display 190 may display a solid number while the plurality of signaling LEDs 166 are flashing or being illuminated in a pattern. In another example, the 14-segment display 190 may display a flashing number while the plurality of signaling LEDs 166 are solid or being illuminated in at a different rate. In some examples the 14-segment display 190 may be illuminated in a first color and the plurality of signaling LEDs 166 may be illuminated in a second color.

In various examples, the system 100 may include at least two emitter devices 110 and at least one target device 160. The individual ones of the at least two emitter devices 110 may be coupled to corresponding user drones 102. For example, a first drone 102-A may be different than a second drone 102-B in size, shape, and/or configuration. The emitter devices 110a, 110b may be configured with individually distinct selectable identifiers to encode a distinct predefined infrared signal 120a from the first emitter 110a coupled to the first drone 10a and different distinct predefined infrared signal 120b from the second emitter 110b coupled to the second drone 10b. The target device 160 is configured to display a score associated with the infrared signal 120a, 120b received from the individual emitter devices 110a, 110b. The score associated with the first emitter 110a of the first drone 10a may be illuminated in a first color and the score associated with the second emitter 110b of the second drone 10b may be illuminated in a second color.

The selectable identifier 126 on the individual emitter device 110 allows the user to select a predefined protocol for an infrared signal 120 to be emitted. In various examples, the user may select an identifier that corresponds to a predefined protocol. In various examples, the user may select from two or more identifiers. For example, the selectable identifier 126 may allow the user to select from six identifiers corresponding to specific protocols of emission of the infrared signal 120 as controlled by the emitter controller 112. For example, the protocol may include an internally-designed protocol, including a series of pulses. In an illustrative example, the infrared emitter 114 pulses on/off according to the superimposition of 3 regular cycles: i) a first high-speed cycle, ii) a second slower cycle used to identify the emitter device 110 and drone 10, and iii) a third slower cycle. The first high-speed cycle may be between 33-43 kHz, preferably 38 kHz. The second slower cycle used to identify the emitter device 110 and the corresponding emitter drone 102-A may include selected frequencies between 600 Hz-2500 Hz. For example, the second slower cycle may be selected from: 2000 Hz, 1666 Hz, 1389 Hz, 1163 Hz, 971 Hz, and 800 Hz. The third slower cycle may be in a range between about 10-15 Hz, preferably 12.5 Hz. Similarly, the target device 160 receiving the infrared signal 120 includes a target controller 164 configured to categorize the received signal according to the same protocol to identify the identity the emitter device 110 and the corresponding emitter drone 102 from which the infrared signal 120 originated.

The emitter controller 112 may be a computing device including a processor and a memory, and program instructions stored in the memory configured to be executed by the processor. For example, the emitter controller 112 may be a microcontroller. The emitter controller 112 may include infrared control 118 and laser control 122 modules that include program instructions to control at least control the infrared emitter 114 and laser emitter 116 of the emitter device 110. The emitter controller 112 may include program instructions to control the emission of an infrared signal 120 simultaneously with the laser beam 124 in response to a transmit signal received by the emitter device 110. The emitter controller 112 may include program instructions to modulate the infrared signal 120 emitted according to a predefined protocol based on an identifier 126 selected by the user. The emitter controller 112 may include program instructions to modify the intensity of the infrared light 120 on a light mode selected by the user.

The target controller 164 may be a computing device including a processor and a memory, and program instructions stored in the memory configured to be executed by the processor. For example, the target controller 164 may be a microcontroller. The target controller 164 may include a counter 170, LED control 172, and display control 174 modules that include program instructions to control at least the plurality of signaling LEDs 166 and display 168 of the target device 160. The target controller 164 may include program instructions to control counting the number of infrared signals received and determining an identifier 126 selected by the user based on the predefined protocol received. The target controller 164 may include program instructions to control the color and/or illumination pattern of the plurality of signaling LEDs 166. The target controller 164 may include program instructions to control the count or score displayed on the display 168 based on the count of infrared signals detected.

In another embodiment, a target device 1160 may differ from the target device 160 in that some or all of the LEDs 166 are omitted and/or the display is omitted. The target device 1160 may include an infrared sensor 1162 and a target controller 1164 contained within a housing 1130. The target controller 1164 configured to at least count the number of infrared signals 1120 detected via a counter 1170. In some examples, the target device 1160 may also include a display 1168. The target housing 1130 is suitable to be coupled to a drone 102. The housing 1130 may have a rectangular prism shape, although housing of other shapes or configurations sized to couple to a drone may be relied on. For example, the housing 1130 may have a length of about 9-15 cm, width of about 3-7 cm, and a height of about 1-5 cm. The target device 1160 may be coupled in a position away from the emitter device 110 and does not communicate with the emitter device 110. For example, the target device 1160 may be coupled to the drone 10, but be independent of flight controller of the drone 10. When installed on the drone 10, the target device 1160 does not interface or communicate with the flight controller 12 of the emitter drone 102-A or any emitter device 110 coupled to the same drone emitter drone 102-A. The target device 1160 may include a replaceable or rechargeable battery. The target device 1160 may be powered by an internal battery or draw power from a battery on the drone; however, the target device 1160 is separate from the flight controller 12 and does not communicate with and is not physically connected to the flight controller.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Although certain embodiments have been described and illustrated in exemplary forms with a certain degree of particularity, it is noted that the description and illustrations have been made by way of example only. Numerous changes in the details of construction, combination, and arrangement of parts and operations may be made. Accordingly, such changes are intended to be included within the scope of the disclosure, the protected scope of which is defined by the claims.

1. A system comprising:
an emitter drone comprising:
one or more emitters that are configured to emit signals;
a receiver drone comprising:
one or more receivers that are configured to detect an emitted signal from the emitter drone, and
a controller that is configured to provide a detection signal when the one or more receivers detect the emitted signal from the emitter drone; and
an indicator that provides an indication based on receiving the detection signal from the controller of the receiver drone.

2. The system of claim 1, wherein the one or more receivers are configured to detect the emitted signal from the emitter drone only when the emitter drone is in a particular position or orientation with respect to the receiver drone.

3. The system of claim 1, wherein the controller is configured to provide the output when the one or more receivers detect the signal from the emitter drone for more than a threshold amount of time.

4. The system of claim 1, wherein the controller is configured to provide the output when the one or more receivers detect the signal from the emitter drone more than a threshold number of times.

5. The system of claim 1, wherein the emitted signal encodes data associated with the emitter drone or the receiver drone.

6. The system of claim 1, wherein the receiver drone comprises a filter that prevents the one or more receivers from detecting emitted signal energy from one or more directions.

7. The system of claim 6, wherein the filter comprises an aperture.

8. A receiver kit for a drone, comprising:
a housing that is configured to attach to a frame of a drone;
one or more receivers that are configured to detect emitted signal from a particular direction, and
a controller inside the housing that is configured to output a detection signal when the one or more receivers detect the emitted signal.

9. The receiver kit of claim 8, comprising:
one or more light elements on the housing that activate when the controller activates the detection signal.

10. The receiver kit of claim 8, comprising:
a transmitter inside the housing that transmits the detection signal to a remote indicator or to another drone.

11. The receiver kit of claim 8, comprising:
a mount for removably attaching the housing to the frame of the drone.

12. The receiver kit of claim 8, wherein the detection signal is output to an onboard controller of the drone.

13. The receiver kit of claim 8, wherein the detection signal encodes data reflecting an extent to which the emitted electromagnetic energy was detected.

14. The receiver kit of claim 8, wherein the detection signal comprises one or more piloting instructions that are provided to the drone.

15. A computer-implemented method comprising:
receiving, by a receiver drone, a signal that is emitted from an emitter drone when the emitter drone is emitting signals and is in a particular position or orientation with respect to the receiver drone;
generating, by the receiver drone, a detection signal; and
providing, by the receiver drone, the detection signal for output.

16. The method of claim 15, wherein the signal is received by the receiver drone only when the emitter drone is directly behind the receiver drone.

17. The method of claim 15, wherein the signal is received by the receiver drone only when the emitter drone is diving toward the receiver drone.

18. The method of claim 15, wherein the receiver drone performs a simulated hit flight maneuver in response to the detection signal.

19. The method of claim 15, wherein providing the detection signal for output comprises transmitting the detection signal to a remote indicator of a controlling user.

20. The method of claim 15, wherein providing the detection signal for output comprises providing the detection signal to an onboard controller of the receiver drone.

21. A system comprising:
an emitter device comprising:
one or more emitters that are configured to emit signals;
a receiver device comprising:
one or more receivers that are configured to detect an emitted signal from the emitter device, and
a controller that is configured to provide a detection signal when the one or more receivers detect the emitted signal from the emitter device; and
an indicator that provides an indication based on receiving the detection signal from the controller of the receiver device.
